(19) United States
(12) Patent Application Publication
(10) Pub. No.: US 2026/0186375 A1
(43) Pub. Date: Jul. 2, 2026

(54) APERTURE DEVICE AND SLIDING ASSEMBLY THEREOF

(71) Applicant: Luxshare Intelligent Manufacture Technology (Changshu) Co.,Ltd, Changshu City (CN)

(72) Inventors: Yi Hsuan CHENG, Changshu City (CN); Shihwei HUNG, Changshu City (CN); Po-Ying TSENG, Changshu City (CN); Hsiao-Hsin HU, Changshu City (CN); Shang Yu HSU, Changshu City (CN); Fu Yuan WU, Changshu City (CN)

(21) Appl. No.: 19/372,761

(22) Filed: Oct. 29, 2025

(30) Foreign Application Priority Data
Dec. 31, 2024 (CN) 2024120004418

(51) Int. Cl. G03B 9/06; G02B 5/00; G03B 7/00

(52) U.S. Cl. CPC G03B 9/06; G02B 5/005; G03B 7/00

(57) ABSTRACT

The present disclosure provides an aperture device and a sliding assembly thereof. The sliding assembly includes a first assembling member, a second assembling member and a plurality of balls. The first assembling member has a plurality of first accommodating grooves formed on a first surface thereof. The second assembling member has a plurality of second accommodating grooves corresponding to the first accommodating grooves respectively. The balls are disposed in the first accommodating grooves and the second accommodating grooves, whereby the first surface slides with respect to the second surface and rotates about the axis. The first accommodating grooves includes at least one first limiting groove, and the second accommodating grooves includes at least one second limiting groove corresponding to the first limiting groove. The first limiting groove and the second limiting groove have walls opposite disposed and inclined with respect to the axis.

### CROSS-REFERENCE TO RELATED APPLICATIONS

This application claims benefits based on an invention which was disclosed in China Patent Application, numbered 2024120004418, filed Dec. 31, 2024, and entitled “Aperture device and sliding assembly thereof”.

### BACKGROUND OF THE INVENTION

### Field of the Invention

The invention relates to a technical field of optical mechanism, and more particularly to an aperture device and a sliding assembly thereof.

### Description of the Related Art

A conventional optical mechanism for auto-focusing includes a voice coil motor moving a lens barrel with respect to a base, thereby moving lenses with respect to an image sensor. A conventional sliding assembly structure between the lens barrel and the base includes two linear guiding grooves and a plurality of balls disposed between the linear guiding grooves. The lens barrel linearly moves with respect to the base through the sliding assembly structure. One of the linear guiding grooves has a cross section of V-shape enabling a precise assembly of the balls with the linear guiding groove.

### BRIEF SUMMARY OF THE INVENTION

An embodiment of the present disclosure provides a sliding assembly. The sliding assembly in accordance with an exemplary embodiment of the present disclosure configured to slide with respect to an axis, includes a first assembling member comprising a first surface perpendicular to the axis and a plurality of first accommodating grooves disposed on the first surface, a second assembling member comprising a second surface corresponding to the first surface and perpendicular to the axis, and a plurality of second accommodating grooves corresponding to the first accommodating grooves respectively, and a plurality of balls disposed on the first accommodating grooves and the second accommodating grooves, whereby the first surface slides about the axis with respect to the second surface, wherein the first accommodating grooves includes at least one first limiting groove, the second accommodating grooves includes at least one second limiting groove corresponding to the first limiting groove, each of the at least one first limiting groove and the at least one second limiting groove has two walls opposite disposed and inclined with respect to the axis, wherein the balls are disposed in the at least one first limiting groove and the at least one second limiting groove, and prop against the walls of the at least one first limiting groove and the walls of the at least one second limiting groove.

In another exemplary embodiment, the at least one first limiting groove and the at least one second limiting groove have curved structures, and the axis extends through a center of the curved structures.

In yet another exemplary embodiment, the at least one first limiting groove has a length along a circumference direction with respect to the axis different from that of the at least one second limiting groove; the at least one first limiting groove has a depth along the axis different from that of the at least one second limiting groove.

In yet another exemplary embodiment, the balls in the at least one first limiting groove and the at least one second limiting groove have identical or different diameters.

In yet another exemplary embodiment, the balls in the at least one first limiting groove and the at least one second limiting groove includes two first balls having a first diameter and one second ball having a second diameter smaller than the first diameter, and the second ball is disposed between the two first balls.

In yet another exemplary embodiment, the first accommodating grooves includes at least one first mounting groove, the second accommodating grooves includes at least one second mounting groove corresponding to the at least one first mounting groove, the at least one first mounting groove and the at least one second mounting groove have walls opposite disposed and parallel to the axis, at least one of the balls is disposed in the at least one first mounting groove and the at least one second mounting groove, a distance between the walls of the at least one first mounting groove is greater than a diameter of the ball, and a distance between the walls of the at least one second mounting groove is greater than a diameter of the ball.

In yet another exemplary embodiment, the at least one first mounting groove and the at least one second mounting groove have curved structure have curved structures, the axis extends through a center of the curved structure, and the at least one first mounting groove has a length along a circumference direction with respect to the axis smaller than that of the at least one second mounting groove.

In yet another exemplary embodiment, the at least one first mounting groove has length along a circumference direction with respect to the axis different from that of the at least one second mounting groove, and the at least one first mounting groove has a depth along the axis different from that of the at least one second mounting groove.

In yet another exemplary embodiment, a center of the at least one first mounting groove is un-aligned with a center of the at least one second mounting groove along the axis.

In yet another exemplary embodiment, the at least one first limiting groove is separated from the at least one first mounting groove by an angular distance of 180°, and the at least one second limiting groove is separated from the at least one second mounting groove by an angular distance of 180°.

An embodiment of the present disclosure provides an aperture device includes the aforementioned sliding assembly, a plurality of blades rotatably disposed in the first assembling member and the second assembling member, wherein the blades overlap each other to constitute an aperture, and a driving member disposed in the first assembling member and the second assembling member, wherein the first assembling member rotates about the axis with respect to the second assembling member, whereby the blades move to alter a diameter of the aperture.

In another exemplary embodiment, the aperture device further includes a pulling structure, wherein the pulling structure includes a plurality of posts and a plurality of pins, the first assembling member further includes a first top surface away from the first surface, the second assembling member further includes a second top surface away from the second surface, the first top surface surrounds the second top surface and rotates about the axis with respect to the second top surface, the posts are disposed on the first top surface, the pins are disposed on the second top surface, and each of the blades has a hole rotatably joined to the post and a slot slidably connected to the pin.

In yet another exemplary embodiment, the first assembling member has an annular structure, the first surface and the first top surface are disposed at two opposite ends of the annular structure; the second assembling member has a barrel structure and an annular flange, the second top surface is located at an axial end of the barrel structure, the annular flange is located at another axial end of the barrel structure away from the second top surface, and the second surface is located at the annular flange.

In yet another exemplary embodiment, the second assembling member further includes a plurality of embossments disposed in the annular flange, the second accommodating groove are formed on the embossments respectively, and the second surface is located on a top surface of the embossment.

In yet another exemplary embodiment, the first assembling member further includes a plurality of protrusion blocks disposed on the first surface, and each of the protrusion blocks is located between the two adjacent embossments.

In yet another exemplary embodiment, the driving member includes at least one magnet disposed in the first assembling member and at least one coil disposed in the second assembling member, current flows through the at least one coil, whereby an electromagnetic effect is generated between the at least one coil and the at least one magnet to move the at least one magnet with respect to the at least one coil.

The sliding assembly and the aperture device of the present disclosure have the following advantageous effects:

As the sliding assembly of some embodiments of the present disclosure includes the first limiting groove and the second limiting groove. The first limiting groove and the second limiting groove both have two walls inclined with respect to the axis. The balls are disposed in the first limiting groove and the second limiting groove to maintain the rotational center of the first assembling member in the predetermined axis when the first assembling member rotates and slides with respect to the second assembling member.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of a first embodiment of an aperture device of the present disclosure;

FIG. 2 is a perspective view of a first embodiment of an aperture device of the present disclosure, wherein a protective cover is removed;

FIG. 3 is an exploded view of the aperture device of FIG. 1;

FIG. 4 is an exploded view of the aperture device of FIG. 1 at another view angle;

FIG. 5 is a cross section of FIG. 1 along a line A-A;

FIG. 5a is another cross section of the aperture device of FIG. 1;

FIG. 6 is a cross section of FIG. 1 along a line B-B;

FIG. 7 is a cross section of FIG. 1 along a line C-C;

FIG. 8 is a perspective view of a second embodiment of an aperture device of the present disclosure;

FIG. 9 is a perspective view of a first embodiment of an aperture device of the present disclosure, wherein a protective cover is removed;

FIG. 10 is an exploded view of the aperture device of FIG. 8;

FIG. 11 is an exploded view of the aperture device of FIG. 8 at another view angle;

FIG. 12 is a cross section of FIG. 8 along a line D-D;

FIG. 12a is another cross section of the aperture device of FIG. 8;

FIG. 13 is a cross section of FIG. 8 along a line E-E; and

FIG. 14 is a cross section of FIG. 8 along a line F-F.

### DETAILED DESCRIPTION OF THE INVENTION

This description is made for the purpose of illustrating the general principles of the invention and should not be taken in a limiting sense.

Regarding an optical mechanism in the prior art, such as an aperture adjustment mechanism, which includes two components rotationally connected to each other to move aperture blades and thereby adjust the diameter of the aperture. An embodiment of the present disclosure addresses a technical issue about how to achieve a slidable connection between the rotating components and precisely maintain the concentric rotation of the components.

Some embodiments of the present disclosure provide an aperture device and a sliding assembly thereof for precisely sliding assembly of the relatively rotating components.

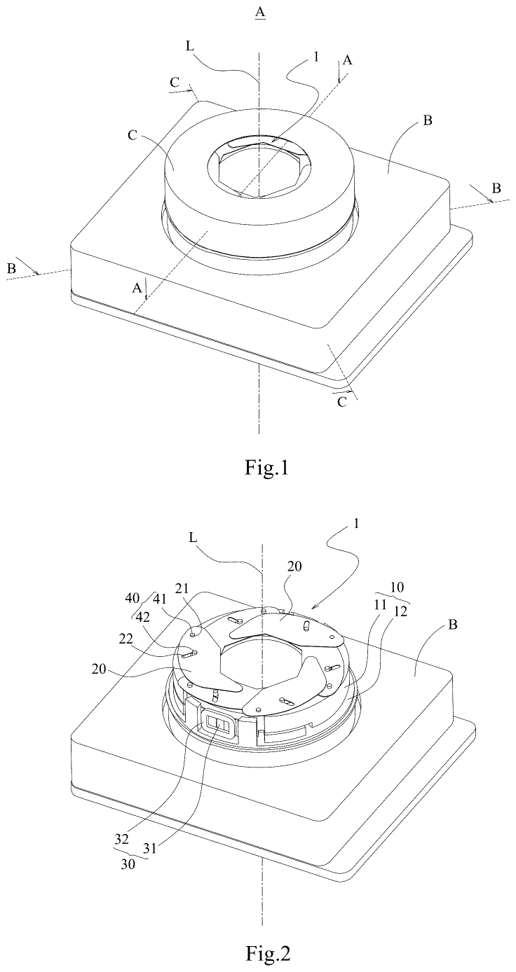

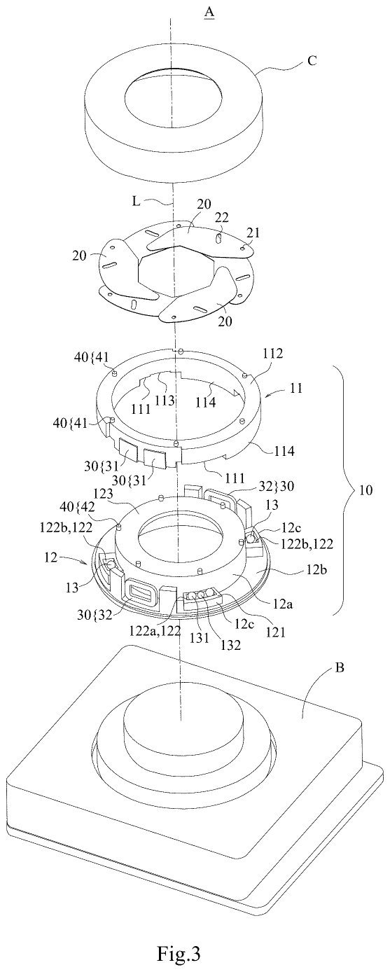

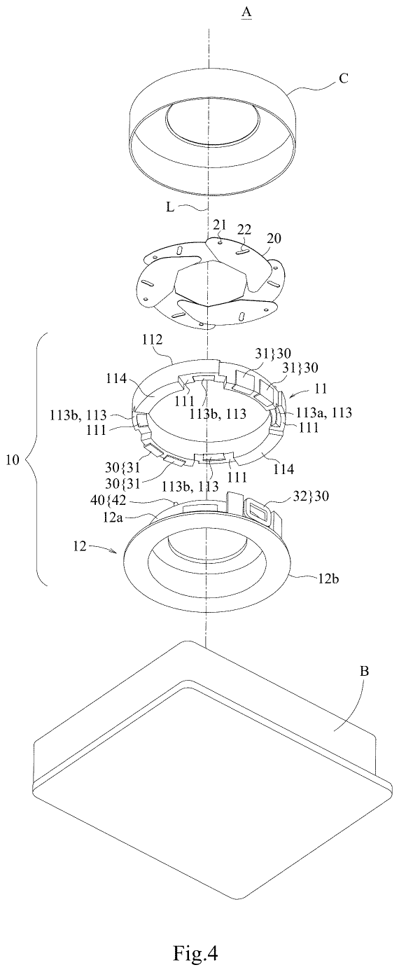

Referring to FIGS. 1, 2, 3 and 4, a first embodiment of an aperture device of the present disclosure is disclosed. The aperture device 1 of the embodiment is disposed at a base B of an optical device A, and an image sensor is disposed on the base B. The aperture device 1 is positioned at a front side of the image sensor. The optical device A has a protective cover C covering the aperture device 1. The aperture device 1 includes a sliding assembly 10, a plurality of blades 20 and a driving member 30. The driving member 30 drives the sliding assembly 10 to rotate about an axis L and slides, whereby the blades 20 move to change a diameter of the aperture. The axis L of the embodiment is coincident with an optical axis of the optical device.

The sliding assembly 10 of the embodiment includes a first assembling member 11, a second assembling member 12 and a plurality of balls 13. The second assembling member 12 is secured in the base B of the optical device. The first assembling member 11 is rotatably joined to the second assembling member 12. The balls 13 are disposed between the first assembling member 11 and the second assembling member 12 and capable of scrolling therebetween, whereby the first assembling member 11 slides with respect to the second assembling member 12 and rotates about the axis L.

The first assembling member 11 has an annular structure. The first assembling member 11 has a first surface 111, a first top surface 112 and a plurality of first accommodating grooves 113. The first surface 111 and the first top surface 112 are two axial end surfaces of the annular structure. The first surface 111 and the first top surface 112 are perpendicular to the axis L. The first surface 111 is located at the end of the first assembling member 11 in vicinity of the second assembling member 12 and the base B. The first top surface 112 is located at the end of the first assembling member 11 away from the second assembling member 12 and the base B. The first accommodating grooves 113 are disposed on the first surface 111 and separated from each other by an identical angular distance thereon.

The second assembling member 12 includes a barrel structure 12a and an annular flange 12b. The annular flange 12b is disposed at one end of the barrel structure 12a in vicinity of the base B and extends radially. The second assembling member 12 further includes a plurality of embossments 12c disposed on a surface of the annular flange 12b away from the base B and adjacent to an outer peripheral surface of the barrel structure 12a. The second assembling member 12 further includes a second surface 121, a plurality of second accommodating grooves 122 and a second top surface 123. Top surfaces of the embossments 12c constitute the second surface 121, and the second accommodating grooves 122 are disposed on the top surfaces of the embossments 12c respectively. That is the second accommodating grooves 122 are disposed on the second surface 121. The second accommodating grooves 122 symmetrically correspond to the first accommodating grooves 113 respectively. The second top surface 123 is located on an axial end surface of the barrel structure 12a away from the base B. The first top surface 112 surrounds the second top surface 123.

The first assembling member 11 includes a plurality of protrusion blocks 114 disposed on the first surface 111. Each of the protrusion blocks 114 is disposed between two adjacent first accommodating grooves 113, whereby each of the protrusion blocks 114 is located between two adjacent embossments 12c when the first assembling member 11 is joined to the second assembling member 12.

The balls 13 are disposed in the first accommodating grooves 113 and the second accommodating grooves 122, whereby the first surface 111 slides with respect to the second surface 121 and rotates about the axis L.

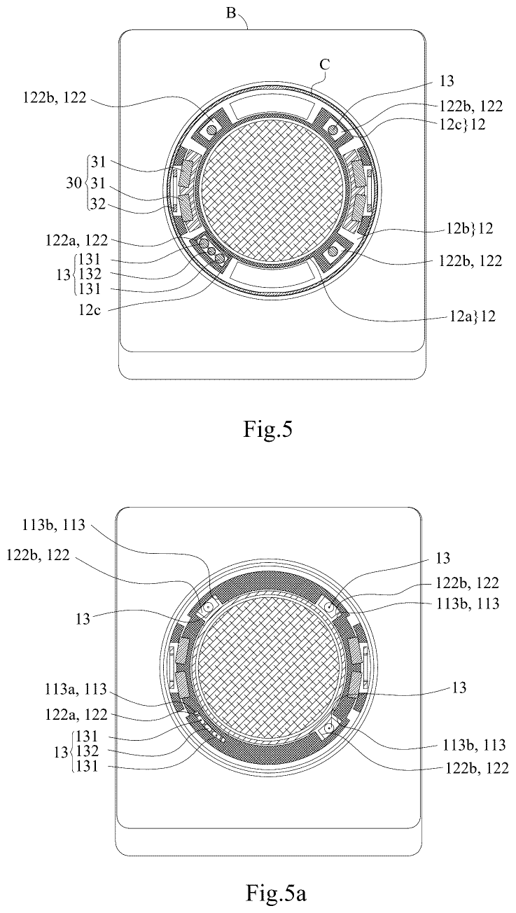

Referring to FIGS. 5, 5a, 6 and 7, the plurality of the first accommodating grooves 113 includes a first limiting groove 113a and three first mounting grooves 113b. The plurality of second accommodating grooves 122 includes a second limiting groove 122a and three second mounting grooves 122b. The first limiting groove 113a corresponds to the second limiting groove 122a. The first mounting grooves 113b correspond to the second mounting grooves 122b respectively. The first limiting groove 113a and the first mounting grooves 113b have curved structures with respect to a center through which the axis L extends. Similarly, the second limiting groove 122a and the second mounting grooves 122b also have curved structures with respect to a center through which the axis L extends.

The first limiting groove 113a and the second limiting groove 122a have two walls opposite disposed and inclined with respect to the axis L. The balls 13 are dis posed in the first limiting groove 113a and the corresponding second limiting groove 122a, whereby the balls prop against the walls 113a1 of the first limiting groove 113a and against the walls 122a1 of the second limiting groove 122a in a scrolling manner. The structure of the balls 13 propping against the first limiting groove 113a and the second limiting groove 122a limits the movement of the first assembling member 11 in the radial direction with respect to the second assembling member 12. The first limiting groove 113a and the second limiting groove 122a have a length along a circumference direction greater than a summation of diameters of the balls 13 therein. That is a predetermined gap exists between the balls 13 and the first limiting groove 113a and the second limiting groove 122a, whereby the first assembling member 11 is movable along the circumference direction with respect to the second assembling member 12. Therefore, a center of the first assembling member 11 is maintained at the axis L or has an allowable variation when the first assembling member 11 slides with respect to the second assembling member 12, thereby obtaining desired precision of operation.

The balls 13 disposed in the first limiting groove 113a and the second limiting groove 122a includes two first balls 131 having a first diameter and a second ball 132 having a second diameter smaller than the first diameter. The second ball 132 is disposed between the first balls 131.

Each of the first mounting grooves 113b has two walls 113b1 opposite disposed and parallel to the axis L, and each of the second mounting grooves 122b has two walls 122b1 opposite disposed and parallel to the axis L. One ball 13 is disposed in the first mounting groove 113b and the second mounting groove 122b. A distance between the walls 113b1 is greater than the diameter of the ball 13, and a distance between the walls 122b1 is greater than the diameter of the ball 13, whereby an allowable tolerance for assembly exists between the balls 13 and the first mounting grooves 113b and the second mounting grooves 122b. Moreover, a line connecting a center of the first mounting groove 113b and a center of the second mounting grooves 122b intersects the axis L. That is the first mounting groove 113b is un-aligned to the second mounting grooves 122b. Therefore, a distance between the wall 113b1 of the first mounting grooves 113b and the wall 122b1 of the second mounting grooves 122b is slightly greater than the diameter of the ball 13 to provide an allowable tolerance for assembly.

Therefore, the structure that the balls 13 props against the first limiting groove 113a and the second limiting groove 122a limits the movement of the first assembling member 11 with respect to the second assembling member 12 to provide a desired precision for operation of the aperture device and provide the allowable tolerance for assembly of the balls 13 in the first mounting groove 113b and the second mounting groove 122b. The rotational precision of the first assembling member 11 with respect to the second assembling member 12 is maintained, and only one position limit is provided for easy assembly of the first assembling member 11 to the second assembling member 12.

The balls 13 disposed in the first mounting groove 113b and the second mounting groove 122b has a diameter the same as that of the balls 13 disposed in the first limiting groove 113a and the second limiting groove 122a, i.e. the first diameter.

The first mounting groove 113b has a length along the circumference direction smaller than that of the first limiting groove 113a, and the second mounting groove 122b has a length along the circumference direction smaller than that of the second limiting groove 122a. The number of the balls 13 in the first limiting groove 113a and the second limiting groove 122a is more than that of the balls 13 in the first mounting groove 113b and the second mounting groove 122b.

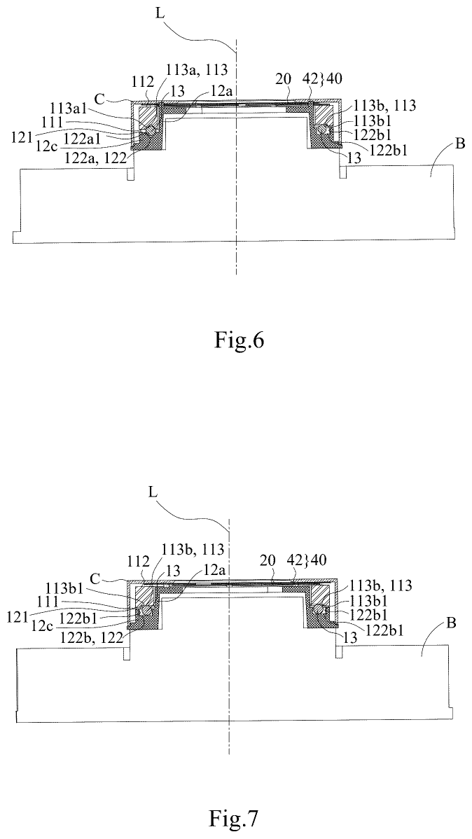

Moreover, as shown in FIG. 5a, the first mounting groove 113b has a length along the circumference direction with respect to a center through which the axis L extends, is different from that of the second mounting groove 122b. The length of the first mounting groove 113b along the circumference direction is greater than that of the second mounting groove 122b. As shown in FIG. 6, the first mounting groove 113b has a depth along the axis L is different from that of the second mounting groove 122b. In the present embodiment, the first mounting groove 113b has the depth smaller than that of the second mounting groove 122b.

The first limiting groove 113 is separated from one of the first mounting groove 113b by an angular distance of 180° with respect to the axis L. The second limiting groove 122a is separated from one of the second mounting groove 122b by an angular distance of 180° with respect to the axis L.

The plurality of the blades 20 are rotatably disposed in the first assembling member 11 and the second assembling member 12. The blades 20 overlap each other to constitute the aperture. The aperture device 1 further includes a pulling structure 40. The pulling structure 40 includes a plurality of posts 41 disposed on the first top surface 112 and a plurality of pins 42 disposed on the second top surface 123. Each of the blades 20 has a hole 21 rotatably joined to the post 41 and a slot 22 slidably connected to the pin 42. When the first assembling member 11 rotates with respect to the second assembling member 12, the first top surface 112 rotates with respect to the second top surface 123, whereby the pin 42 pulls the slot 22 to rotate the blades 20 about the post 41 so as to increase or decrease the diameter of the aperture.

The driving member 30 includes a pair of magnets 31 disposed in the first assembling member 11 and a pair of coils 32 disposed in the second assembling member 12. Current flows through the coil 32, and electromagnetic effects are generated between the magnets 31 and the coils 32, whereby the magnets 31 move with respect to the coils 32. Therefore, the first assembling member 11 rotates about the axis L and moves with respect to the second assembling member 12, whereby the plurality of blades 20 move to alter the diameter of the aperture.

Although the first accommodating grooves 113 include one first limiting groove 113a, and the second accommodating grooves 122 include one second limiting groove 122a, the invention is not limited thereto. In other embodiments, the plurality of first accommodating grooves includes two first limiting grooves or three first limiting grooves, or each first accommodating grooves is the first limiting groove. The plurality of second accommodating grooves includes two second limiting grooves or three second limiting grooves, or each second accommodating grooves is the second limiting groove.

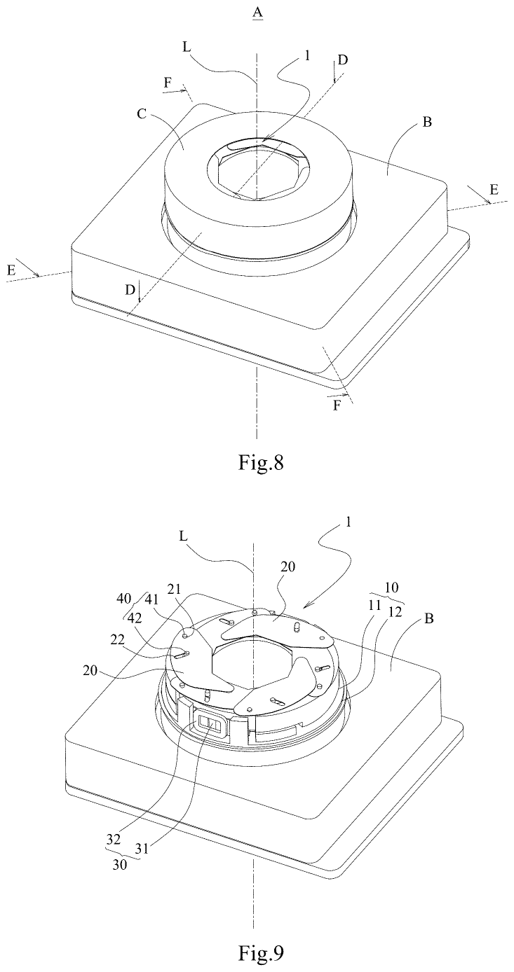

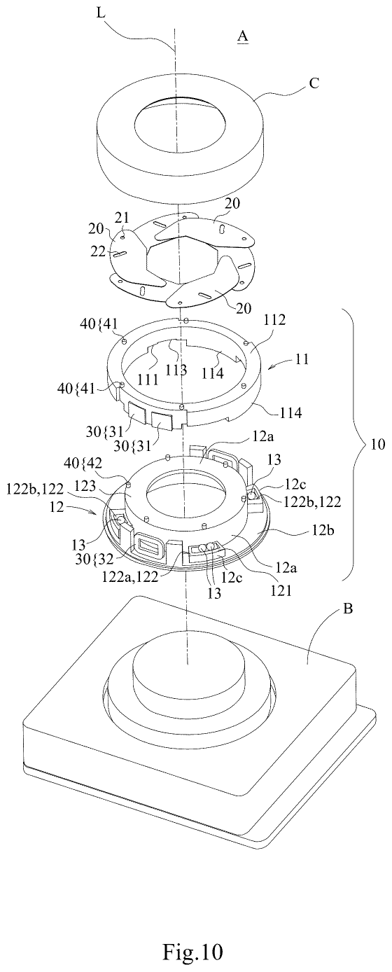

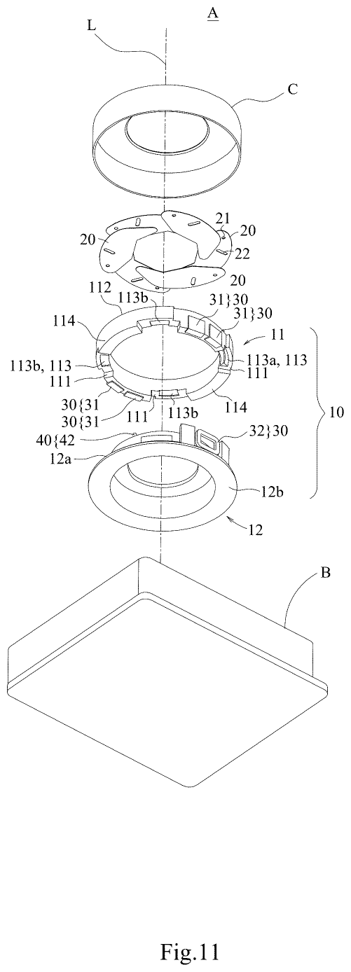

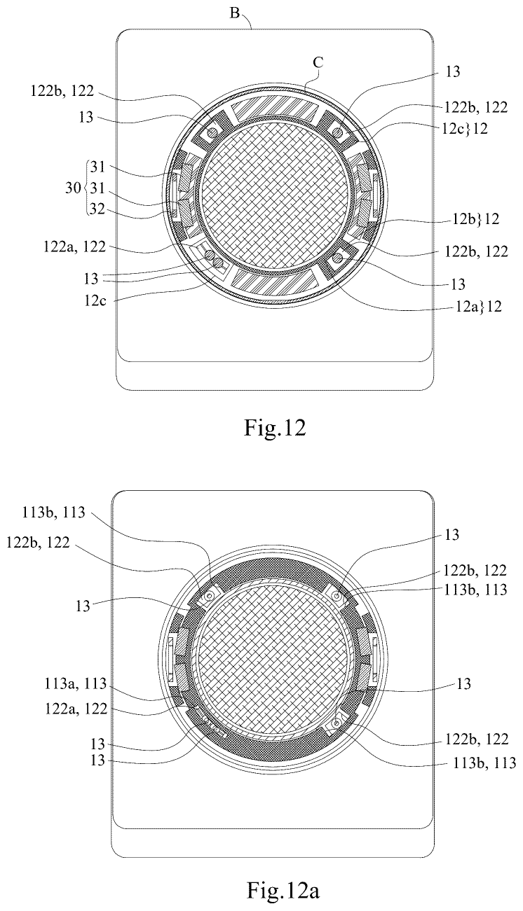

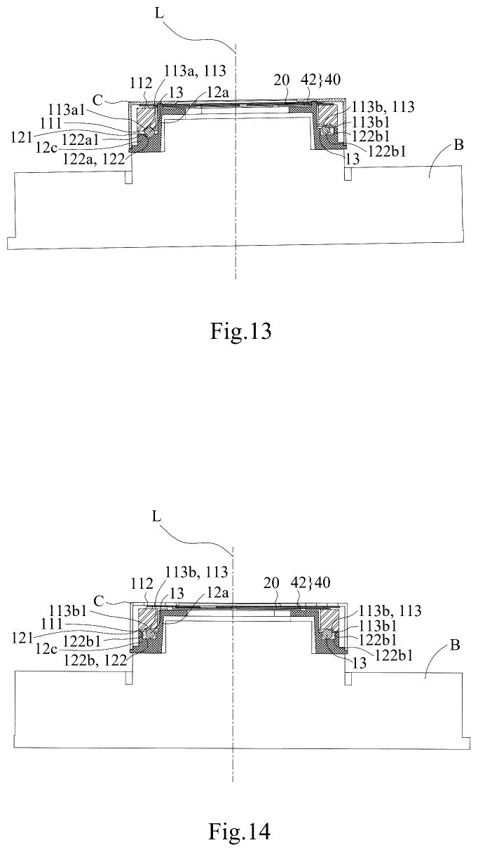

Referring to FIGS. 8, 9, 10, 11, 12, 12a, 13 and 14, the second embodiment of the aperture device is disclosed. The embodiment has a structure partially identical to the structure of the first embodiment, and therefore identical numerical are given to identical elements and the descriptions thereof are thus omitted. The present embodiment differs from the first embodiment in that the balls 13 disposed in the first limiting groove 113a and the second limiting groove 122a have the identical diameter, and the balls disposed in the first mounting groove 113b and the second mounting groove 122b has a diameter the same as that of the balls 13 disposed in the first limiting groove 113a and the second limiting groove 122a. In some embodiments, two balls have the same diameter are disposed in the first limiting groove 113a and the second limiting groove 122a.

Although the first accommodating grooves 113 include one first limiting groove 113a, and the second accommodating grooves 122 include one second limiting groove 122a, the invention is not limited thereto. In other embodiments, the plurality of first accommodating grooves includes two first limiting grooves or three first limiting grooves, or each first accommodating grooves is the first limiting groove. The plurality of second accommodating grooves includes two second limiting grooves or three second limiting grooves, or each second accommodating grooves is the second limiting groove.

As the sliding assembly of some embodiments of the present disclosure includes the first limiting groove and the second limiting groove. The first limiting groove and the second limiting groove both have two walls inclined with respect to the axis. The balls are disposed in the first limiting groove and the second limiting groove to maintain the rotational center of the first assembling member in the predetermined axis when the first assembling member rotates and slides with respect to the second assembling member.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sliding assembly configured to slide with respect to an axis, comprising:
a first assembling member comprising a first surface perpendicular to the axis and a plurality of first accommodating grooves disposed on the first surface;
a second assembling member comprising a second surface corresponding to the first surface and perpendicular to the axis, and a plurality of second accommodating grooves corresponding to the first accommodating grooves respectively; and
a plurality of balls disposed on the first accommodating grooves and the second accommodating grooves, whereby the first surface slides about the axis with respect to the second surface;
wherein the first accommodating grooves comprises at least one first limiting groove, the second accommodating grooves comprises at least one second limiting groove corresponding to the first limiting groove, each of the at least one first limiting groove and the at least one second limiting groove comprises two walls opposite disposed and inclined with respect to the axis;
wherein the balls are disposed in the at least one first limiting groove and the at least one second limiting groove, and prop against the walls of the at least one first limiting groove and the walls of the at least one second limiting groove.

2. The sliding assembly as claimed in claim 1, wherein the at least one first limiting groove and the at least one second limiting groove have curved structures, and the axis extends through a center of the curved structures.

3. The sliding assembly as claimed in claim 1, wherein the at least one first limiting groove has a length along a circumference direction with respect to the axis different from that of the at least one second limiting groove; the at least one first limiting groove has a depth along the axis different from that of the at least one second limiting groove.

4. The sliding assembly as claimed in claim 2, wherein the balls in the at least one first limiting groove and the at least one second limiting groove have identical or different diameters.

5. The sliding assembly as claimed in claim 1, wherein the balls in the at least one first limiting groove and the at least one second limiting groove comprises two first balls having a first diameter and one second ball having a second diameter smaller than the first diameter, and the second ball is disposed between the two first balls.

6. The sliding assembly as claimed in claim 5, wherein the first accommodating grooves comprises at least one first mounting groove, the second accommodating grooves comprises at least one second mounting groove corresponding to the at least one first mounting groove, the at least one first mounting groove and the at least one second mounting groove have walls opposite disposed and parallel to the axis, at least one of the balls is disposed in the at least one first mounting groove and the at least one second mounting groove, a distance between the walls of the at least one first mounting groove is greater than a diameter of the ball, and a distance between the walls of the at least one second mounting groove is greater than a diameter of the ball.

7. The sliding assembly as claimed in claim 6, wherein the at least one first mounting groove and the at least one second mounting groove have curved structure have curved structures, the axis extends through a center of the curved structure, and the at least one first mounting groove has a length along a circumference direction with respect to the axis smaller than that of the at least one second mounting groove.

8. The sliding assembly as claimed in claim 6, wherein the at least one first mounting groove has a length along a circumference direction with respect to the axis different from that of the at least one second mounting groove, and the at least one first mounting groove has a depth along the axis different from that of the at least one second mounting groove.

9. The sliding assembly as claimed in claim 6, wherein a center of the at least one first mounting groove is un-aligned with a center of the at least one second mounting groove along the axis.

10. The sliding assembly as claimed in claim 6, wherein the at least one first limiting groove is separated from the at least one first mounting groove by an angular distance of 180°, and the at least one second limiting groove is separated from the at least one second mounting groove by an angular distance of 180°.

11. An aperture device, comprising:
the sliding assembly as claimed in claim 1;
a plurality of blades rotatably disposed in the first assembling member and the second assembling member, wherein the blades overlap each other to constitute an aperture; and
a driving member disposed in the first assembling member and the second assembling member, wherein the first assembling member rotates about the axis with respect to the second assembling member, whereby the blades move to alter a diameter of the aperture.

12. The aperture device as claimed in claim 11, further comprising a pulling structure, wherein the pulling structure comprises a plurality of posts and a plurality of pins, the first assembling member further comprises a first top surface away from the first surface, the second assembling member further comprises a second top surface away from the second surface, the first top surface surrounds the second top surface and rotates about the axis with respect to the second top surface, the posts are disposed on the first top surface, the pins are disposed on the second top surface, and each of the blades comprises a hole rotatably joined to the post and a slot slidably connected to the pin.

13. The aperture device as claimed in claim 12, wherein the first assembling member further comprises an annular structure, the first surface and the first top surface are disposed at two opposite ends of the annular structure; the second assembling member further comprises a barrel structure and an annular flange, the second top surface is located at an axial end of the barrel structure, the annular flange is located at another axial end of the barrel structure away from the second top surface, and the second surface is located at the annular flange.

14. The aperture device as claimed in claim 13, wherein the second assembling member further comprises a plurality of embossments disposed in the annular flange, the second accommodating groove are formed on the embossments respectively, and the second surface is located on a top surface of the embossment.

15. The aperture device as claimed in claim 14, wherein the first assembling member further comprises a plurality of protrusion blocks disposed on the first surface, and each of the protrusion blocks is located between the two adjacent embossments.

16. The aperture device as claimed in claim 11, wherein the driving member comprises at least one magnet disposed in the first assembling member and at least one coil disposed in the second assembling member, current flows through the at least one coil, whereby an electromagnetic effect is generated between the at least one coil and the at least one magnet to move the at least one magnet with respect to the at least one coil.
